(19) United States
(12) Patent Application Publication
(10) Pub. No.: US 2019/0033666 A1
(43) Pub. Date: Jan. 31, 2019

(54) DISPLAY PANEL, METHOD FOR MANUFACTURING SAME, AND DISPLAY APPARATUS USING SAME

(71) Applicants: HKC Corporation Limited, Shenzhen City, Guangdong (CN); Chongqing HKC Optoelectronics Technology Co., Ltd., Chongqing (CN)

(72) Inventor: Chung-Kuang CHIEN, Chongqing (CN)

(73) Assignees: HKC Corporation Limited, Shenzhen City, Guangdong (CN); Chongqing HKC Optoelectronics Technology Co., Ltd., Chongqing (CN)

(21) Appl. No.: 15/578,466

(22) PCT Filed: Sep. 4, 2017
(86) PCT No.: PCT/CN2017/100324

§ 371 Date: Nov. 30, 2017

(30) Foreign Application Priority Data
Jul. 25, 2017 (CN) 201710611591.X

(51) Int. Cl. G02F 1/1337; G02F 1/1335; G02F 1/137; G02F 1/1339; G02F 1/1333

(52) U.S. Cl. CPC G02F 1/133788; G02F 1/133512; G02F 1/133723; G02F 1/1368; G02F 1/1339; G02F 1/133308; G02F 1/137

(57) ABSTRACT

This application relates to a display panel. The display panel includes: a first substrate, including a display area and an edge area, where the edge area surrounds the display area; a light shield layer, disposed on the edge area of the first substrate; a first alignment film, disposed on the first substrate; a second substrate, including a display area and an edge area, and disposed opposite to the first substrate; a second alignment film, disposed on the second substrate; a liquid crystal layer, disposed between the first substrate and the second substrate, and doped with a liquid crystal reactive monomer generating a polymeric effect upon light; and a plurality of spacing units, disposed on the first substrate, where a light permeable layer is disposed on the edge area of the second substrate, and the light permeable layer is disposed opposite to the light shield layer of the first substrate.

### BACKGROUND

### Technical Field

This application relates to a display panel, a method for manufacturing same, and a display apparatus using same, and in particular, to a display panel, in which no light shield layer is formed on an edge area of an inner surface of a substrate.

### Related Art

A liquid crystal display (Liquid Crystal Display, LCD) is a flat panel display apparatus displaying an image by using attributes of a liquid crystal material. Compared with other display apparatuses, the liquid crystal display has advantages such as a light and thin design, a low drive voltage, and low power consumption, and has become the mainstream on the entire consumption market. A liquid crystal panel is a most important component of the liquid crystal display, and includes an active switch array (TFT) array substrate, a color filter (CF) substrate, and a liquid crystal layer and alignment films disposed between the two substrates, where the active switch array (TFT) array substrate, the color filter (CF) substrate, the liquid crystal layer and the alignment films are laminated in a vacuum manner. The alignment films are disposed on the TFT array substrate and the CF substrate, and are used to control liquid crystal cells of the liquid crystal layer to be arranged in a preset initial state, so as to affect the display attribute of the liquid crystal panel. A polymer stabilized vertical alignment (Polymer Stabilized Vertical Alignment, PSVA) technology in a manufacturing process of an alignment film has gradually become the mainstream due to features such as a high penetration rate, a high contrast ratio, and a fast response. In an exemplary PSVA technology, first, a liquid crystal reactive monomer (RM) is doped in a liquid crystal, and then power is supplied to enable a liquid crystal cell to generate a pretilt angle to make the RM linked to polyimide (PI) of an alignment film, and finally ultraviolet light is irradiated to make a polymer monomer reacted into a polymer, so that the pretilt angle of the liquid crystal cell is fixed.

However, at the stage of irradiating the ultraviolet light to make the polymer monomer reacted into polymer, due to a light shield layer (such as a black matrix) on a substrate, the ultraviolet light usually fails to be irradiated on the liquid crystal reactive monomer in a part shielded by the light shield layer. Consequently, the liquid crystal reactive monomer near the light shield layer performs incomplete polymerization reaction, leading to the case of image sticking fail on a panel. To resolve this problem, and to conform to the trend in recent years towards a bezel-less design of a TFT-LCD to highlight the integration of a displayed image, the foregoing problem needs to be resolved by using a configuration for adjusting a light shield layer.

### SUMMARY

To resolve the foregoing technical problem, an objective of this application is to provide a display panel, a method for manufacturing same, and a display apparatus using same, and this application particularly relates to a display panel, in which no light shield layer is formed on an inner surface of a substrate. According to this application, not only a manufacturing process of forming a light shield layer on a substrate can be omitted, but also cases of irradiating ultraviolet light on a shielded polymer monomer can be greatly reduced, to sufficiently irradiate the ultraviolet light, so that a liquid crystal reactive monomer can perform complete polymerization reaction, thereby reducing image sticking.

The objective of this application is achieved and the technical problem of this application is resolved by using the following technical solution. A display panel provided according to this application comprises: a first substrate, comprising a display area and an edge area, wherein the edge area surrounds the display area; a light shield layer, disposed on the edge area of the first substrate; a first alignment film, disposed on the first substrate; a second substrate, comprising a display area and an edge area, and disposed opposite to the first substrate; a second alignment film, disposed on the second substrate; a liquid crystal layer, disposed between the first substrate and the second substrate, and doped with a liquid crystal reactive monomer generating a polymeric effect upon light; and a plurality of spacing units, disposed on the first substrate, wherein a light permeable layer is disposed on the edge area of the second substrate, and the light permeable layer is disposed opposite to the light shield layer of the first substrate.

In an embodiment of this application, some of the spacing units located on the edge area of the first substrate are in contact with the second substrate.

In an embodiment of this application, the spacing units are made from photoresist materials.

In an embodiment of this application, the light permeable layer is disposed on the edge area of the second substrate, and the light permeable layer is disposed opposite to the light shield layer.

In an embodiment of this application, a material of the first alignment film is polyimide.

In an embodiment of this application, a material of the second alignment film is polyimide.

The objective of this application may further be achieved and the technical problem of this application may further be resolved by using the following technical solution.

Another objective of this application is a display apparatus, comprising: a backlight module, and further comprising the display panel.

In an embodiment of this application, some of the spacing units located on the edge area of the first substrate are in contact with the second substrate.

In an embodiment of this application, the spacing units are made from photoresist materials.

In an embodiment of this application, a material of the first alignment film is polyimide.

In an embodiment of this application, a material of the second alignment film is polyimide.

In the foregoing embodiment, a frame-shaped light shield layer is disposed on a frame of an outer surface, back to the liquid crystal layer, of the first substrate, and a front frame is further comprised, wherein the front frame is fixed on the outer surface of the first substrate.

In the foregoing embodiment, a frame-shaped light shield layer is disposed on a frame of an outer surface, back to the liquid crystal layer, of the second substrate, and a front frame is further comprised, wherein the front frame is fixed on the outer surface of the second substrate.

This application is implemented by using the following technical solution. A method for manufacturing a display panel provided according to this application comprises steps: providing a first substrate, comprising a display area and an edge area, wherein the edge area surrounds the display area; disposing a light shield layer, a first alignment film, and a plurality of spacing units on the edge area of the first substrate; providing a second substrate, comprising a display area and an edge area, and disposed opposite to the first substrate; disposing a light permeable layer and a second alignment film on the second substrate; disposing, between the first substrate and the second substrate, a liquid crystal layer doped with a liquid crystal reactive monomer generating a polymeric effect upon light; supplying power to enable the liquid crystal reactive monomer to be linked to alignment materials of the alignment films; performing light irradiation for a first time towards a direction of the second substrate, so that the liquid crystal reactive monomer forms a preliminary polymerization phenomenon; and performing light irradiation for a second time towards the direction of the second substrate, so that the liquid crystal reactive monomer forms a complete polymerization phenomenon, wherein the light shield layer of the first substrate is disposed opposite to the light permeable layer (the edge area) of the second substrate. Therefore, when light irradiation is performed towards the direction of the second substrate, the light shield layer does not affect the polymeric effect of the liquid crystal reactive monomer upon light.

According to this application, not only a manufacturing process of forming a light shield layer on a substrate can be omitted, but also cases of irradiating ultraviolet light on a shielded polymer monomer can be greatly reduced, to sufficiently irradiate the ultraviolet light, so that a liquid crystal reactive monomer can perform complete polymerization reaction, thereby reducing image sticking.

### BRIEF DESCRIPTION OF THE DRAWINGS

FIG. 1A is a schematic structural diagram of an exemplary display panel before light irradiation;

FIG. 1B is a schematic diagram of a light irradiation reaction for a first time of the exemplary display panel;

FIG. 1C is a schematic diagram of a light irradiation reaction for a second time of the exemplary display panel;

FIG. 1D is a schematic structural diagram of the exemplary display panel after light irradiation;

FIG. 2A is a schematic structural diagram of a display panel of this application before light irradiation;

FIG. 2B is a schematic diagram of a light irradiation reaction for a first time of the display panel of this application;

FIG. 2C is a schematic diagram of a light irradiation reaction for a second time of the display panel of this application;

FIG. 2D is a schematic structural diagram of the display panel of this application after light irradiation;

FIG. 3A is a schematic structural diagram of a light shield layer of an outer surface according to an embodiment of this application;

FIG. 3B is a schematic structural diagram of a light shield layer of an outer surface according to another embodiment of this application;

FIG. 4A is a schematic structural diagram of an embodiment of a display apparatus according to this application; and

FIG. 4B is a schematic structural diagram of another embodiment of a display apparatus according to this application.

### DETAILED DESCRIPTION

The following embodiments are described with reference to the accompanying drawings, used to exemplify specific embodiments for implementation of this application. Terms about directions mentioned in this application, such as “on”, “below”, “front”, “back”, “left”, “right”, “in”, “out”, and “side surface” merely refer to directions in the accompanying drawings. Therefore, the used terms about directions are used to describe and understand this application, and are not intended to limit this application.

The accompanying drawings and the description are considered to be essentially exemplary, rather than limitative. In the figures, modules with similar structures are represented by using the same reference number. In addition, for understanding and ease of description, the size and the thickness of each component shown in the accompanying drawings are arbitrarily shown, but this application is not limited thereto.

In the accompanying drawings, for clarity, thicknesses of a layer, a film, a panel, an area, and the like are enlarged. In the accompanying drawings, for understanding and ease of description, thicknesses of some layers and areas are enlarged. It should be understood that when a component such as a layer, a film, an area, or a base is described to be “on” “another component”, the component may be directly on the another component, or there may be an intermediate component.

In addition, throughout this specification, unless otherwise explicitly described to have an opposite meaning, the word “include” is understood as including the component, but not excluding any other component. In addition, throughout this specification, “on” means that one is located above or below a target component and does not necessarily mean that one is located on the top based on a gravity direction.

To further describe the technical means used in this application to achieve the application objective and effects thereof, specific implementations, structures, features, and effects of a display panel, a method for manufacturing same, and a display apparatus using same provided according to this application are described in detail below with reference to the drawings and preferred embodiments.

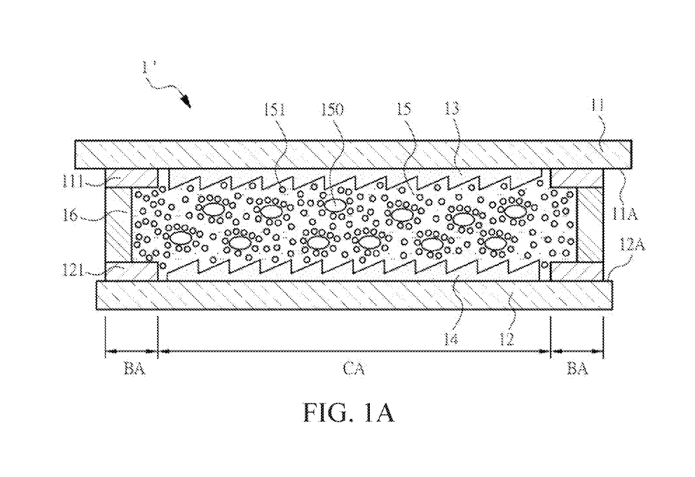

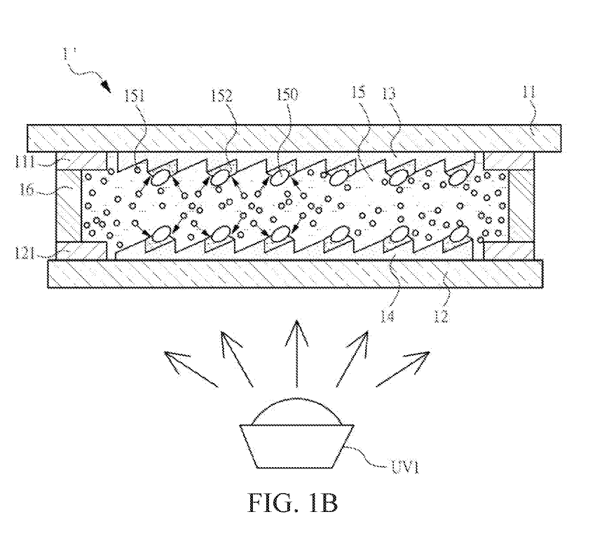

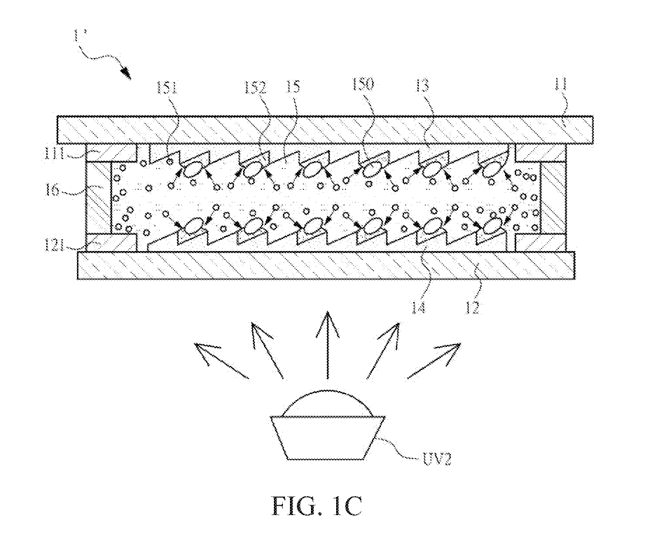

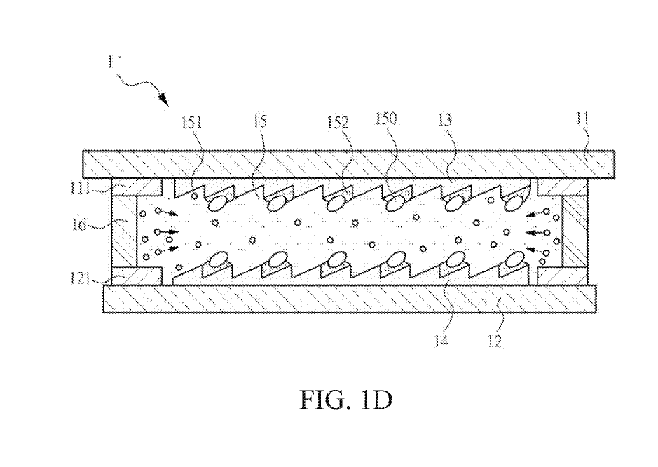

Referring to FIG. 1A to FIG. 1D, FIG. 1A to FIG. 1D are respectively a schematic structural diagram of an exemplary display panel 1′ before light irradiation, a schematic diagram of a light irradiation reaction for a first time of the exemplary display panel 1′, a schematic diagram of a light irradiation reaction for a second time of the exemplary display panel 1′, and a schematic structural diagram of the exemplary display panel 1′ after light irradiation. The exemplary display panel 1′ includes a display area CA and an edge area BA. The edge area BA surrounds the display area CA. The exemplary display panel 1′ includes: a first substrate 11, including an inner surface 11A, where a color filter layer and a light shied layer 111 are formed on the inner surface 11A; a first alignment film 13, disposed on the inner surface 11A of the first substrate 11; a second substrate 12, disposed opposite to the first substrate 11, and including an inner surface 12A, where a light shield layer 121 (such as a black matrix) is formed on a part, corresponding to the edge area BA, of the inner surface 12A; a second alignment film 14, disposed on the inner surface 12A of the second substrate; and a liquid crystal layer 15, disposed between the first substrate 11 and the second substrate 12, and doped with a liquid crystal reactive monomer 151 generating a polymeric effect upon light irradiation, where a plurality of spacing units 16 is disposed on the edge area BA of the inner surface. The liquid crystal layer 15 contains a liquid crystal cell 150, and is doped with the liquid crystal reactive monomer 151 (RM). In a manufacturing process, by supplying power, the liquid crystal cell 15 is enabled to generate a pretilt angle to make the liquid crystal reactive monomer 151 linked to the alignment films (such as a material polyimide PI), and finally ultraviolet light UV1 is irradiated for a first time, and ultraviolet light UV2 is irradiated for a second time to make the liquid crystal reactive monomer 151 reacted into a liquid crystal polymer 152, so that the pretilt angle of the liquid crystal cell 150 is fixed.

However, as shown in FIG. 1B and FIG. 1C, at the stage of irradiating the ultraviolet light UV1 and UV2 to make the liquid crystal reactive monomer 151 reacted into the liquid crystal polymer 152, due to the light shield layer 121 on the second substrate 12, the ultraviolet light usually fails to be irradiated on the liquid crystal reactive monomer 151 in a part shielded by the light shield layer 121 (as shown in FIG. 1C). Consequently, the liquid crystal reactive monomer 151 near the light shield layer 121 (that is, the edge area BA) performs incomplete polymerization reaction, leading to the case, as shown in FIG. 1D, of image sticking fail on the panel caused by the incompletely polymerized liquid crystal reactive monomer 151 after light irradiation is completed.

To resolve this problem, and to conform to the trend in recent years towards a bezel-less design of a TFT-LCD to highlight the integration of a displayed image, according to this application, a color filter on a color filter (CF) substrate is formed on an active switch array (TFT) array substrate by using a manufacturing process, and a light shield layer on an edge area BA of the color filter (CF) substrate is eliminated, and a light shield layer is formed on an outer surface of a substrate on a line-of-sight side of a user to prevent lateral leakage of light. In this way, the cases of irradiating ultraviolet light on the shielded liquid crystal reactive monomer can be greatly reduced, to sufficiently irradiate the ultraviolet light, so that the liquid crystal reactive monomer can perform complete polymerization reaction, thereby reducing cases of image sticking on the panel.

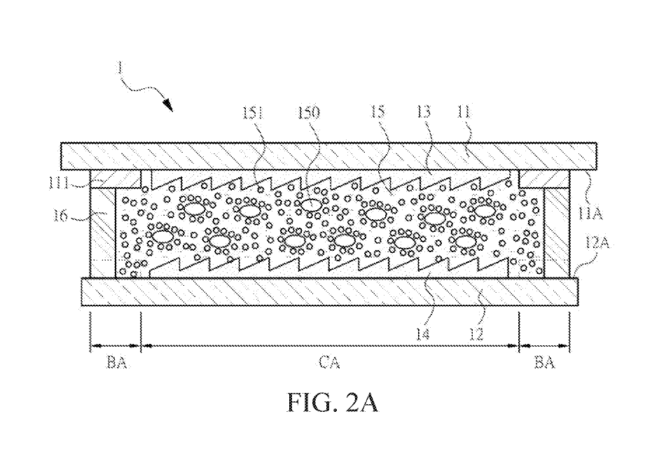

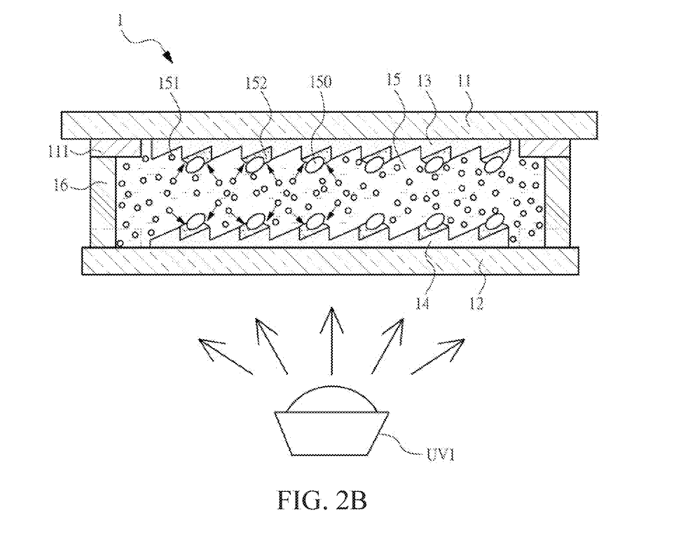

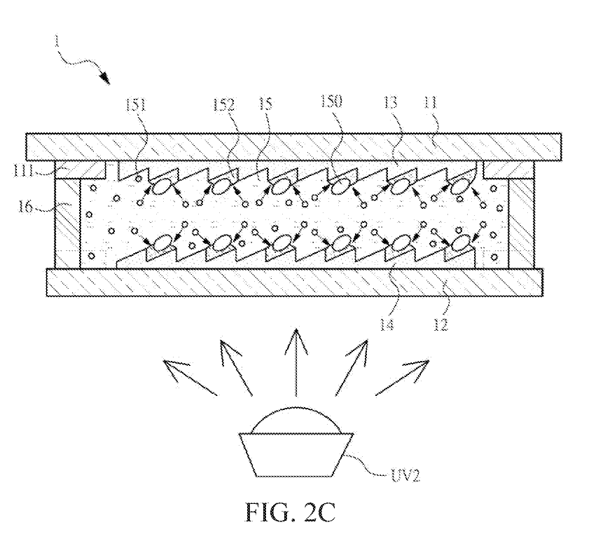

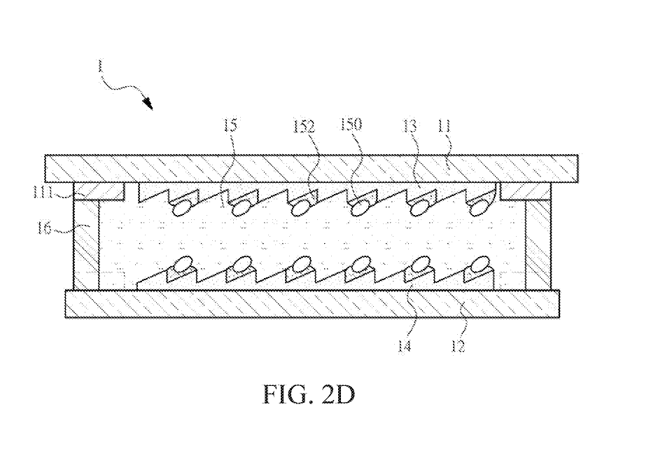

Refer to FIG. 2A to FIG. 2D for the structure of this application. FIG. 2A to FIG. 2D are a schematic structural diagram of a display panel 1 of this application before light irradiation, a schematic diagram of a light irradiation reaction for a first time of the display panel 1 of this application, a schematic diagram of a light irradiation reaction for a second time of the display panel 1 of this application, and a schematic structural diagram of the display panel 1 of this application after light irradiation. The structure of the display panel 1 includes: a first substrate 11, including an inner surface 11A, where the inner surface 11A includes a display area CA and an edge area BA, and the edge area BA surrounds the display area CA; a light shield layer 111, disposed on the edge area BA of the first substrate 11; a first alignment film 13, disposed on the inner surface 11A of the first substrate 11; a second substrate 12, including an inner surface 12A, where the inner surface 12A includes a display area CA and an edge area BA, disposed opposite to the first substrate 11; a second alignment film 14, disposed on the inner surface 12A of the second substrate 12; a liquid crystal layer 15, disposed between the first substrate 11 and the second substrate 12, and doped with a liquid crystal reactive monomer (RM) 151 generating a polymeric effect upon light; and a plurality of spacing units 16, disposed between the first substrate 11 and the second substrate 12. The light shield layer 111 of the first substrate 11 is disposed opposite to the edge area BA of the second substrate 12. The display area CA and the edge area BA are a display area and a non-display area of the corresponding display panel. The liquid crystal layer 15 contains a liquid crystal cell 150, and is doped with the liquid crystal reactive monomer 151. In a manufacturing process, by supplying power, the liquid crystal cell 15 is enabled to generate a pretilt angle to make the liquid crystal reactive monomer 151 linked to the alignment films (such as a material polyimide PI), and finally ultraviolet light UV1 is irradiated for a first time, and ultraviolet light UV2 is irradiated for a second time to make the liquid crystal reactive monomer 151 reacted into a liquid crystal polymer 152, so that the pretilt angle of the liquid crystal cell 150 is fixed.

In an embodiment, the first substrate 11 is an active switch array substrate. A color filter is formed on a surface, corresponding to the display area CA, of the active switch array substrate. A light permeable layer with high transmittance rather than the light shield layer 121 shown in FIG. 1A is disposed on the edge area BA of the second substrate 12. The light permeable layer is disposed opposite to the light shield layer 111.

In an embodiment, some of the spacing units 16 located on the edge area BA of the first substrate 11 are in contact with the second substrate 12, and the spacing units 16 are made from photoresist materials.

In an embodiment, the materials of the first alignment film 13 and the second alignment film 14 are polyimide (PI).

Based on the feature of this application that no light shield layer (for example, the black matrix light shield layer 121 shown in FIG. 1A) is formed on the edge area of the second substrate 12, at the stage of light irradiation (for example, ultraviolet light UV1 is irradiated for a first time as shown in FIG. 2B, and ultraviolet light UV2 is irradiated for a second time as shown in FIG. 2C) on the liquid crystal reactive monomer 151 in the manufacturing process, the cases of irradiating ultraviolet light on the shielded liquid crystal reactive monomer can be greatly reduced, to sufficiently irradiate the ultraviolet light, so that the liquid crystal reactive monomer 151 near the edge area can perform complete polymerization reaction into a liquid crystal polymer 152, thereby reducing cases of image sticking on the panel (as shown in FIG. 2D).

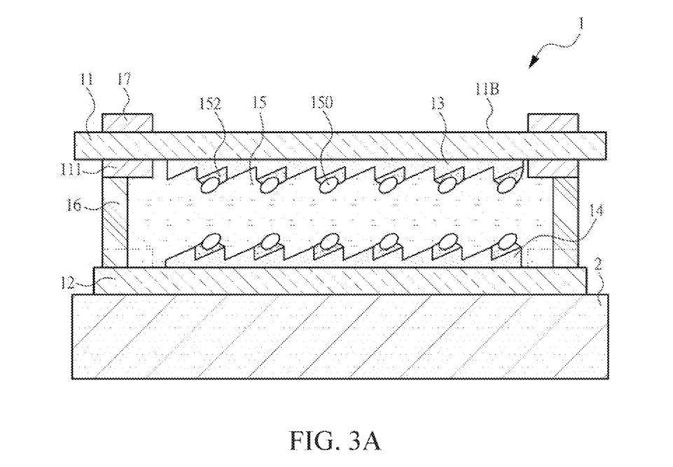

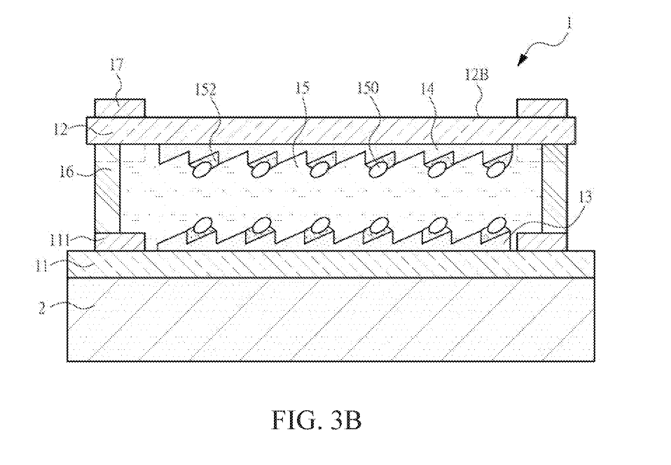

However, in actual application of this application, because the foregoing display panel 1 cannot perform self-illumination, a backlight module 2 is needed to provide light rays. Therefore, another objective of this application is a display apparatus, including: a backlight module 2, and the display panel 1. FIG. 3A is a schematic structural diagram of a light shield layer according to an embodiment of this application. FIG. 3B is a schematic structural diagram of a light shield layer according to another embodiment of this application.

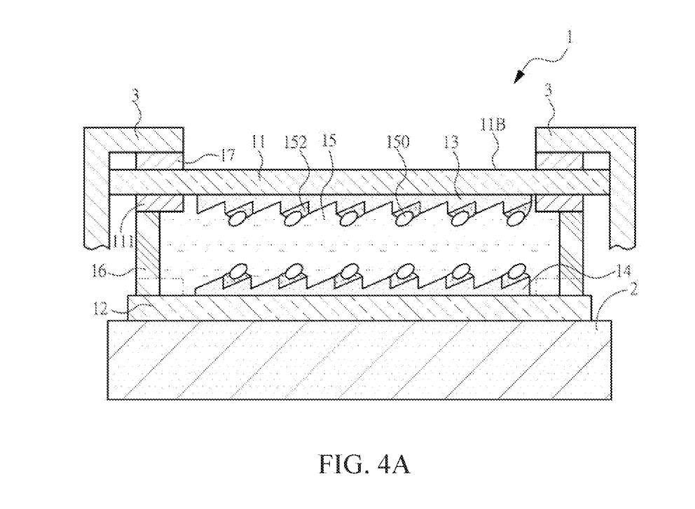

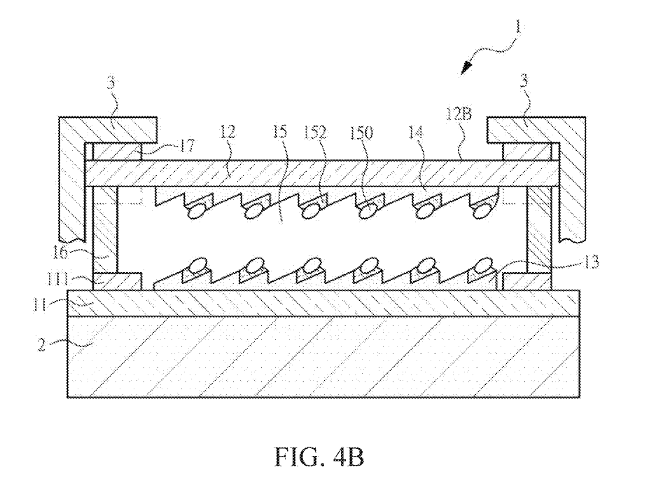

FIG. 4A is a schematic structural diagram of an embodiment of a display apparatus according to this application. Referring to FIG. 3A and FIG. 4A, a display apparatus includes a backlight module 2 and a display panel 1. The structure of the display panel 1 includes: a first substrate 11, where a light shield layer 111 is formed on a corresponding edge area BA of the first substrate 11; a first alignment film 13, disposed on the first substrate 11; a second substrate 12, disposed opposite to the first substrate 11, and the light shield layer 121 shown in FIG. 1A is not formed in a corresponding edge area BA of the second substrate 12; a second alignment film 14, disposed on the second substrate 12; a liquid crystal layer 15, disposed between the first substrate 11 and the second substrate 12, and doped with a liquid crystal reactive monomer (RM) 151 generating a polymeric effect upon light irradiation; and a plurality of spacing units 16, disposed between the first substrate 11 and the second substrate 12. The spacing units 16 disposed on the corresponding edge area are in direct contact with an edge area of an inner surface of the second substrate 12. The liquid crystal layer 15 contains a liquid crystal cell 150, and is doped with the liquid crystal reactive monomer 151. In a manufacturing process, by supplying power, the liquid crystal cell 15 is enabled to generate a pretilt angle to make the liquid crystal reactive monomer 151 linked to the alignment films (such as a material polyimide PI), and finally ultraviolet light UV1 is irradiated for a first time, and ultraviolet light UV2 is irradiated for a second time to make the liquid crystal reactive monomer 151 reacted into a liquid crystal polymer 152, so that the pretilt angle of the liquid crystal cell 150 is fixed.

In an embodiment, the first substrate 11 is an active switch array substrate. A color filter is formed on a surface, corresponding to the display area CA, of the active switch array substrate. A light permeable layer with high transmittance rather than the light shield layer 121 shown in FIG. 1A is disposed on the edge area BA of the second substrate 12. The light permeable layer is disposed opposite to the light shield layer 111.

In an embodiment, some of the spacing units 16 located on the edge area BA of the first substrate 11 are in contact with the second substrate 12, and the spacing units 16 are made from photoresist materials.

In an embodiment, the materials of the first alignment film 13 and the second alignment film 14 are polyimide (PI).

In this embodiment, a frame-shaped light shield layer 17 (such as a black matrix) is disposed on a frame of an outer surface 11B, back to the liquid crystal layer 15, of the first substrate 11.

In this embodiment, a front frame 3 is further included. The front frame 3 is fixed on the outer surface 11B of the first substrate 11, as shown in FIG. 4A.

Based on the feature of this application that no light shield layer is formed on the edge area BA of the second substrate 12, opposite to the case, as shown in FIG. 1A, where the light shield layer 121 is formed on the edge area BA of the second substrate 12, at the stage of light irradiation (for example, ultraviolet light UV1 is irradiated for a first time as shown in FIG. 2B, and ultraviolet light UV2 is irradiated for a second time as shown in FIG. 2C) on the liquid crystal reactive monomer 151 in the manufacturing process, the cases of irradiating ultraviolet light on the shielded liquid crystal reactive monomer can be greatly reduced, to sufficiently irradiate the ultraviolet light, so that the liquid crystal reactive monomer 151 can perform complete polymerization reaction into a liquid crystal polymer 152, thereby reducing cases of image sticking on the panel (as shown in FIG. 2D).

FIG. 4B is a schematic structural diagram of another embodiment of a display apparatus according to this application. Referring to FIG. 3B and FIG. 4B, a display apparatus includes a backlight module 2 and a display panel 1. The structure of the display panel 1 includes: a first substrate 11, where a light shield layer 111 is formed on a corresponding edge area BA of the first substrate 11; a first alignment film 13, disposed on the first substrate 11; a second substrate 12, disposed opposite to the first substrate 11, and the light shield layer 121 shown in FIG. 1A is not formed in a corresponding edge area BA of the second substrate 12; a second alignment film 14, disposed on the second substrate 12; a liquid crystal layer 15, disposed between the first substrate 11 and the second substrate 12, and doped with a liquid crystal reactive monomer (RM) 151 generating a polymeric effect upon light irradiation; and a plurality of spacing units 16, disposed between the first substrate 11 and the second substrate 12. The spacing units 16 disposed on the corresponding edge area are in direct contact with an edge area of an inner surface of the second substrate 12. The liquid crystal layer 15 contains a liquid crystal cell 150, and is doped with the liquid crystal reactive monomer 151. In a manufacturing process, by supplying power, the liquid crystal cell 15 is enabled to generate a pretilt angle to make the liquid crystal reactive monomer 151 linked to the alignment films (such as a material polyimide PI), and finally ultraviolet light UV1 is irradiated for a first time, and ultraviolet light UV2 is irradiated for a second time to make the liquid crystal reactive monomer 151 reacted into a liquid crystal polymer 152, so that the pretilt angle of the liquid crystal cell 150 is fixed.

In an embodiment, the first substrate 11 is an active switch array substrate. A color filter is formed on a surface, corresponding to the display area CA, of the active switch array substrate. A light permeable layer with high transmittance rather than the light shield layer 121 shown in FIG. 1A is disposed on the edge area BA of the second substrate 12. The light permeable layer is disposed opposite to the light shield layer 111.

In an embodiment, some of the spacing units 16 located on the edge area BA of the first substrate 11 are in contact with the second substrate 12, and the spacing units 16 are made from photoresist materials.

In an embodiment, the materials of the first alignment film 13 and the second alignment film 14 are polyimide (PI).

In this embodiment, a frame-shaped light shield layer 17 (such as a black matrix) is disposed on a frame of an outer surface 12B, back to the liquid crystal layer 15, of the second substrate 12.

In this embodiment, a front frame 3 is further included. The front frame 3 is fixed on the outer surface 12B of the second substrate 12, as shown in FIG. 4B.

Based on the feature of this application that no light shield layer (for example, the black matrix light shield layer 121 shown in FIG. 1A) is formed on the edge area of the second substrate 12, at the stage of light irradiation (for example, ultraviolet light UV1 is irradiated for a first time as shown in FIG. 2B, and ultraviolet light UV2 is irradiated for a second time as shown in FIG. 2C) on the liquid crystal reactive monomer 151 in the manufacturing process, the cases of irradiating ultraviolet light on the shielded liquid crystal reactive monomer can be greatly reduced, to sufficiently irradiate the ultraviolet light, so that the liquid crystal reactive monomer 151 can perform complete polymerization reaction into a liquid crystal polymer 152, thereby reducing cases of image sticking on the panel (as shown in FIG. 2D).

The display panel of this application is manufactured by using a method for manufacturing a display panel, including steps: providing a first substrate 11, including a display area CA and an edge area BA, where the edge area BA surrounds the display area CA; disposing a light shield layer 111, a first alignment film 13, and a plurality of spacing units 16 on the edge area BA of the first substrate 11; providing a second substrate 12, including a display area CA and an edge area BA, and disposed opposite to the first substrate 11; disposing a second alignment film 14 on the second substrate 12; disposing, between the first substrate 11 and the second substrate 12, a liquid crystal layer 15 doped with a liquid crystal reactive monomer 151 generating a polymeric effect upon light; supplying power to enable the liquid crystal reactive monomer 151 to be linked to alignment materials of the alignment films 13 and 14; performing light irradiation for a first time towards a direction of the second substrate 12, so that the liquid crystal reactive monomer 151 forms a preliminary polymerization phenomenon; and performing light irradiation for a second time towards the direction of the second substrate 12, so that the liquid crystal reactive monomer 151 forms a complete polymerization phenomenon. The light shield layer 111 of the first substrate 11 is disposed opposite to the edge area BA of the second substrate 12. Therefore, when light irradiation is performed towards the direction of the second substrate 12, the light shield layer 111 does not affect the polymeric effect of the liquid crystal reactive monomer 151 upon light. The display panel may be a TN-type, an OCB-type, a VA-type, or a curved-surface-type display panel. However, this application is not limited thereto. The display panel may use straight down backlight. A backlight source may be a white light source, an RGB three-color light source, an RGBW four-color light source, or an RGBY four-color light source. However, this application is not limited thereto.

According to this application, not only a manufacturing process of forming a light shield layer on a substrate can be omitted, but also cases of irradiating ultraviolet light on a shielded polymer monomer can be greatly reduced, to sufficiently irradiate the ultraviolet light, so that a liquid crystal reactive monomer can perform complete polymerization reaction, thereby reducing image sticking.

The wordings such as “in some embodiments” and “in various embodiments” are repeatedly used. They usually do not refer to a same embodiment; but they may refer to a same embodiment. The words, such as “comprise”, “have”, and “include”, are synonyms, unless other meanings are indicated in the context thereof.

Descriptions above are merely preferred embodiments of this application, and are not intended to limit this application. Although this application has been disclosed above in forms of preferred embodiments, the embodiments are not intended to limit this application. A person skilled in the art can make some equivalent variations, alterations or modifications to the above disclosed technical content without departing from the scope of the technical solutions of the above disclosed technical content to obtain equivalent embodiments. Any simple alteration, equivalent change or modification made to the foregoing embodiments according to the technical essence of this application without departing from the content of the technical solutions of this application shall fall within the scope of the technical solutions of this application.

What is claimed is:

1. A display panel, comprising:
a first substrate, comprising a display area and an edge area, wherein the edge area surrounds the display area;
a light shield layer, disposed on the edge area of the first substrate;
a first alignment film, disposed on the first substrate;
a second substrate, comprising a display area and an edge area, and disposed opposite to the first substrate;
a second alignment film, disposed on the second substrate;
a liquid crystal layer, disposed between the first substrate and the second substrate, and doped with a liquid crystal reactive monomer generating a polymeric effect upon light; and
a plurality of spacing units, disposed on the first substrate, wherein
a light permeable layer is disposed on the edge area of the second substrate, and the light permeable layer is disposed opposite to the light shield layer of the first substrate.

2. The display panel according to claim 1, wherein some of the spacing units located on the edge area of the first substrate are in contact with the second substrate.

3. The display panel according to claim 1, wherein the spacing units are made from photoresist materials.

4. The display panel according to claim 1, wherein a material of the first alignment film is polyimide.

5. The display panel according to claim 1, wherein a material of the second alignment film is polyimide.

6. A display apparatus, comprising:
a backlight module; and
a display panel, comprising:
a first substrate, comprising a display area and an edge area, wherein the edge area surrounds the display area;
a light shield layer, disposed on the edge area of the first substrate;
a first alignment film, disposed on the first substrate;
a second substrate, comprising a display area and an edge area, and disposed opposite to the first substrate;
a second alignment film, disposed on the second substrate;
a liquid crystal layer, disposed between the first substrate and the second substrate, and doped with a liquid crystal reactive monomer generating a polymeric effect upon light; and
a plurality of spacing units, disposed on the first substrate, wherein
a light permeable layer is disposed on the edge area of the second substrate, and the light permeable layer is disposed opposite to the light shield layer of the first substrate.

7. The display apparatus according to claim 6, wherein some of the spacing units located on the edge area of the first substrate are in contact with the second substrate.

8. The display apparatus according to claim 6, wherein the spacing units are made from photoresist materials.

9. The display apparatus according to claim 6, wherein a material of the first alignment film is polyimide.

10. The display apparatus according to claim 6, wherein a material of the second alignment film is polyimide.

11. The display apparatus according to claim 6, wherein a frame-shaped light shield layer is disposed on a frame of an outer surface, back to the liquid crystal layer, of the first substrate.

12. The display apparatus according to claim 11, further comprising a front frame, wherein the front frame is fixed on the outer surface of the first substrate.

13. The display apparatus according to claim 6, wherein a frame-shaped light shield layer is disposed on a frame of an outer surface, back to the liquid crystal layer, of the second substrate.

14. The display apparatus according to claim 13, further comprising a front frame, wherein the front frame is fixed on the outer surface of the second substrate.

15. A method for manufacturing a display panel, comprising:
providing a first substrate, comprising a display area and an edge area, wherein the edge area surrounds the display area;
disposing a light shield layer, a first alignment film, and a plurality of spacing units on the edge area of the first substrate;
providing a second substrate, disposed opposite to the first substrate;
disposing a light permeable layer and a second alignment film on the second substrate;
disposing, between the first substrate and the second substrate, a liquid crystal layer doped with a liquid crystal reactive monomer generating a polymeric effect upon light;
supplying power to enable the liquid crystal reactive monomer to be linked to alignment materials of the alignment films;
performing light irradiation for a first time towards a direction of the second substrate, so that the liquid crystal reactive monomer forms a preliminary polymerization phenomenon; and
performing light irradiation for a second time towards the direction of the second substrate, so that the liquid crystal reactive monomer forms a complete polymerization phenomenon, wherein
the light shield layer of the first substrate is disposed opposite to the light permeable layer of the second substrate.
